(19) United States
(12) Patent Application Publication
(10) Pub. No.: US 2017/0169027 A1
(43) Pub. Date: Jun. 15, 2017

(54) Determining a Display Order for Values in a Multi-Value Field of an Application Card

(71) Applicant: Quixey, Inc., Mountain View, CA (US)

(72) Inventor: Jonathan BEN-TZUR, Sunnyvale, CA (US)

(21) Appl. No.: 14/968,831

(22) Filed: Dec. 14, 2015

(51) Int. Cl. G06F 17/30; G06F 3/0481

(52) U.S. Cl. CPC G06F 17/3053; G06F 3/0481; G06F 17/30395; G06F 17/30554

(57) ABSTRACT

A card server that provides a card object to a mobile computing device in response to receiving a card request from the mobile computing device. The mobile computing device can utilize the card object to display an application card at the mobile computing device. The application card may include one or more multi-value data fields. A multi-value data field refers to a data field with multiple values. The card object may specify the values of the multi-value data field. Additionally, the card object may specify a display order for the values in the multi-value data field. The display order may indicate a sequence in which the values are to be rendered. The card server determines the display order for the values based on a previous search query that the card server received from the mobile computing device.

### TECHNICAL FIELD

This disclosure relates to determining a display order for values in a multi-value field of an application card.

### BACKGROUND

Many mobile computing devices can display a graphical user interface that allows a user of the mobile computing device to enter a search query. Upon receiving the search query from the user, the mobile computing device can transmit the search query to a search server. The search server can generate search results based on the search query. Upon generating the search results, the search server can send the search results to the mobile computing device. The mobile computing device receives the search results, and can display the search results on a display of the mobile computing device. Some mobile computing devices can display the search results in the form of a card. The card may include various data fields. Some data fields may include multiple values. Such data fields may be referred to as multi-value data fields. For example, a data field that displays the cast of a movie may include the names of several actors that were casted in the movie. When a data field includes multiple values, the values may be displayed according to a default display order. In the example of the data field that displays the cast, a leading actor's name may appear before a supporting actor's name. There may be a need to modify the display order for the values in a multi-value data field for different mobile computing devices.

### SUMMARY

One aspect of the disclosure provides a card server. The card server may include a network communication device, a storage device, and a processing device. The storage device may store a query log, and a card data store. The query log stores search queries that the card server receives from mobile computing devices. The card data store stores card records. The card records may correspond with application states of various applications. A card record may include one or more multi-value data fields. A multi-value data field may include multiple values. The processing device may execute computer-readable instructions that, when executed by the processing device, cause the processing device to receive a card request from a mobile computing device. The card request may include a search query with one or more search terms, and a device identifier (ID) that identifies the mobile computing device that sent the card request.

Upon receiving the card request, the processing device may select one or more card records from the card data store based on the search terms in the search query. The processing device can identify a previous search query that the card server received from the mobile computing device based on the search queries stored in the query log. The processing device may identify one or more multi-value fields in the selected card record. For each multi-value field, the processing device can determine a display order for the values in the multi-value field based on the previous search query. The processing device can generate a card object that includes the values from the multi-value data fields of the selected card record, and the display order for each multi-value data field. The processing device can utilize the network communication device to transmit the card object to the mobile computing device.

In some implementations, determining the display order for the values may include determining a dissimilarity score for each value. The dissimilarity score may indicate an amount of dissimilarity between the value, and the previous search query. Upon determining the dissimilarity scores, the processing device can arrange the values in ascending order of the dissimilarity scores associated with the values. In some examples, determining the dissimilarity score for a value may refer to computing a Levenshtein distance between the value, and the previous search query. The Levenshtein distance may indicate a number of single-character modifications that may be needed to transform the value into the previous search query.

In some implementations, the storage device may store an entity graph that stores information regarding entities. The entity graph may include various nodes that may be connected via various edges. Each node in the entity graph may represent an entity. Determining the display order for the values in the multi-value field may include identifying an entity associated with the previous search query based on the entity graph. For each value in the multi-value field, the processing device can identify an entity associated with the value. The processing device can determine a graph distance between a first graph node for the entity associated with the previous search query, and a second graph node for the entity associated with the value. Upon determining the graph distances for all the values in the multi-value data field, the processing device can arrange the values in ascending order of the graph distances that are associated with the values.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic diagram of a system that determines a display order for values in a multi-value data field of an application card.

FIGS. 2A-2D are diagrams of application cards in which the display order for values of various multi-value data fields is modified based on a previous search query.

FIG. 3 is a block diagram of a card server that determines the display order for values of a multi-value data field based on a previous search query that the card server received from a mobile computing device.

FIG. 4 is a block diagram of a method that the card server may execute to determine the display order for the values of a multi-value data field based on a previous search query from the mobile computing device.

Like reference symbols in the various drawings indicate like elements.

### DETAILED DESCRIPTION

The present disclosure provides a system that may be used to render an application card at a mobile computing device based on a search query initiated by the mobile computing device. The application card may include various data fields. The data fields may store one or more values. A data field that stores a single value may be referred to as a single value data field, whereas a data field that stores multiple values may be referred to as a multi-value data field. The system may include a card server that receives card requests from various mobile computing devices. Each card request may include a search query. Upon receiving a current search query from a mobile computing device, the card server can identify an application record that can be used to generate the application card. If the application record includes multi-value fields, then the card server can determine a display order for the values of the multi-value field. The card server may determine the display order based on a previous search query that the card server received from the mobile computing device.

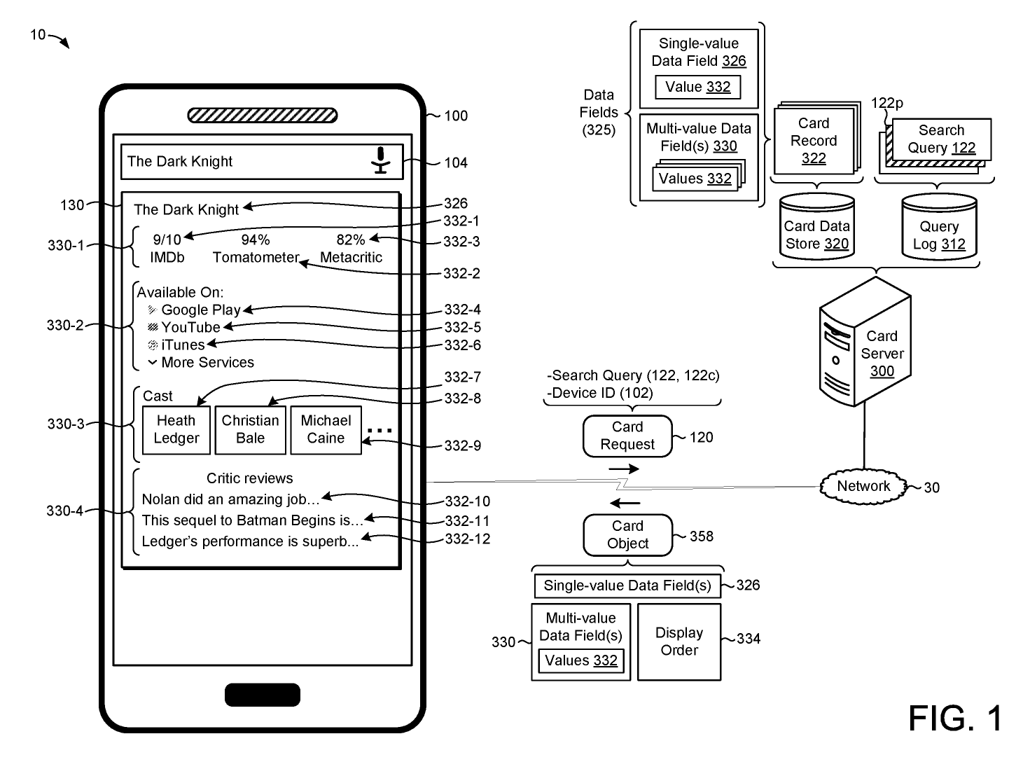

FIG. 1 illustrates a schematic diagram of a system 10 that provides application cards 130 to a mobile computing device 100. The system 10 may include the mobile computing device 100, and a card server 300. The mobile computing device 100, and the card server 300 can communicate via a network 30. The network 30 may include a wireless network (e.g., a cellular network), or a wired network. In operation, the mobile computing device 100 can transmit (e.g., send) a card request 120 to the card server 300. The card request 120 can include a search query 122, and a device identifier (ID) 102 that identifies the mobile computing device 100. The search query 122 in the card request 120 may be referred to as a current search query 122c. In response to transmitting the card request 120, the mobile computing device 100 receives a card object 358 from the card server 300. The card object 358 may include information that the mobile computing device 100 can utilize to render the application card 130.

The card server 300 may include a query log 312, and a card data store 320. The query log 312 stores search queries 122 that the card server 300 receives from various mobile computing devices. Each search query 122 in the query log 312 may be associated with a device ID 102 that identifies the mobile computing device that initiated the search query 122. The card data store 320 stores various card records 322. Each card record 322 may include one or more data fields 325. Each data field 325 may include one or more values 332. A data field 325 that includes a single value 332 may be referred to as a single-value data field 326, whereas a data field 325 that includes multiple values 332 may be referred to as a multi-value data field 330.

In the example of FIG. 1, the application card 130 is for The Dark Knight movie. In this example, the application card 130 includes a single-value data field 326 that displays a movie title. The application card 130 also includes four multi-value data fields 330: a ratings field 330-1, a services field 330-2, an actor field 330-3, and a reviews field 330-4. The ratings field 330-1 shows the ratings for the movie. The ratings field 330-1 includes three rating values 332: an IMDb® rating 332-1, a Tomatometer® rating 332-2, and a Metacritic® rating 332-3. The services field 330-2 shows a list of services where the movie may be available for download, or playback. The services field 330-2 displays three service values 332: Google Play® 332-4, YouTube® 332-5, and iTunes® 332-6. The actor field 330-3 shows a list of actors that were casted in the movie. The actor field 330-3 displays three actor values 332: Heath Ledger 332-7, Christian Bale 332-8, and Michael Caine 332-9. Similarly, the reviews field 330-4 displays three reviews: a first review 332-10, a second review 332-11, and a third review 332-12.

The card server 300 determines a display order 334 for the values 332 in a multi-value data field 330. The display order 334 may indicate an order in which the values 332 of the multi-value data fields 330 can be displayed when the application card 130 is rendered at the mobile computing device 100. In other words, the display order 334 may indicate a sequence in which the values 332 can be arranged when the values 332 are displayed within the application card 130. The card server 300 can determine the display order 334 based on one or more previous search queries 122p that the card server 300 received from the mobile computing device 100. In some implementations, a previous search query 122p may refer to the last search query that the card server 300 received from the mobile computing device 100. In some implementations, a previous search query 122p may refer to the last search query that the card server 300 received from the mobile computing device 100 when the mobile computing device 100 was at its current location. The card server 300 can identify the previous search query 122p received from the mobile computing device 100 based on the device ID 102 specified in the card request 120.

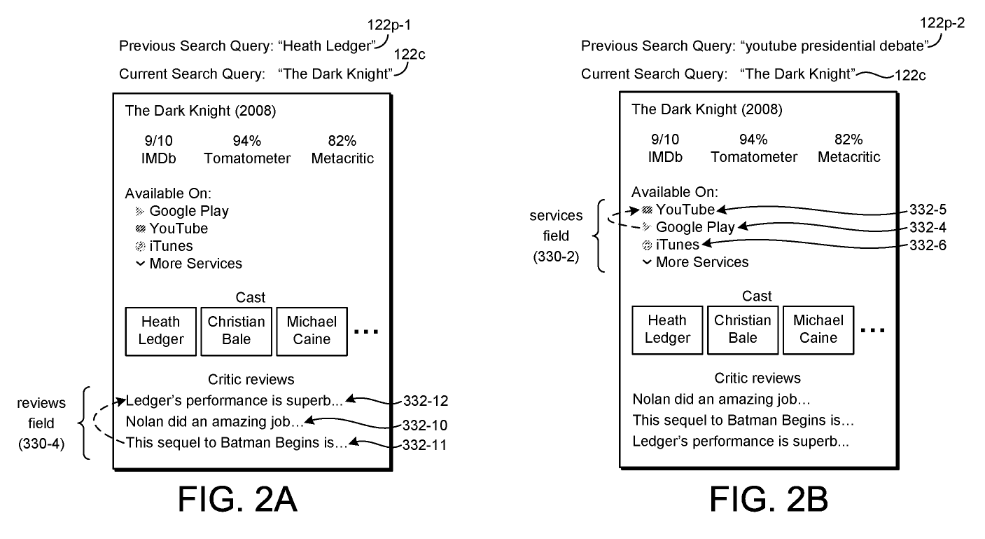

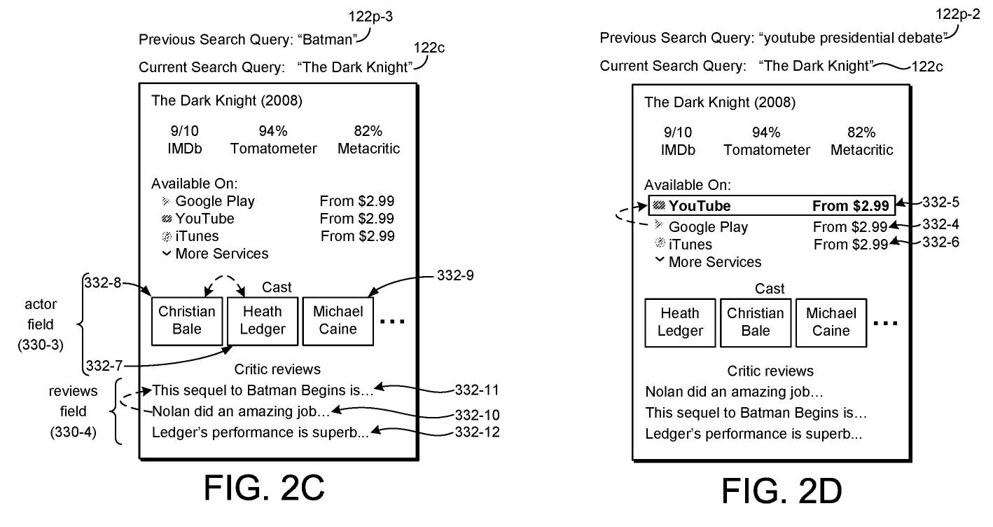

FIGS. 2A-2D show example application cards 130 in which the display order 334 for the values 332 of a multi-value data field 330 is determined based on a previous search query 122p that the mobile computing device 100 transmitted. In the example of FIG. 2A, the current search query 122c is “The Dark Knight”. Accordingly, the mobile computing device 100 displays an application card 130 for The Dark Knight movie. In this example, the previous search query 122p-1 was “Heath Ledger”. As exemplified, reviews that include search terms from the previous search query 122p-1 are displayed towards the top of the application card 130. For example, the third review 332-12 is displayed above the other reviews 332-10, 332-11 because the third review 332-12 mentioned “Ledger”—a search term from the previous search query 122p-1.

In the example of FIG. 2B, the current search query 122c is “The Dark Knight”, and the previous search query 122p-2 was “youtube presidential debate”. In this example, the previous search query 122p-2 affects the display order 334 for the service values 332-4, 332-5, 332-6 in the services field 332. Specifically, YouTube® 332-5 is displayed before Google Play® 332-4, and iTunes® 332-6 because the previous search query 122-2 included “youtube . . . ” as a search term.

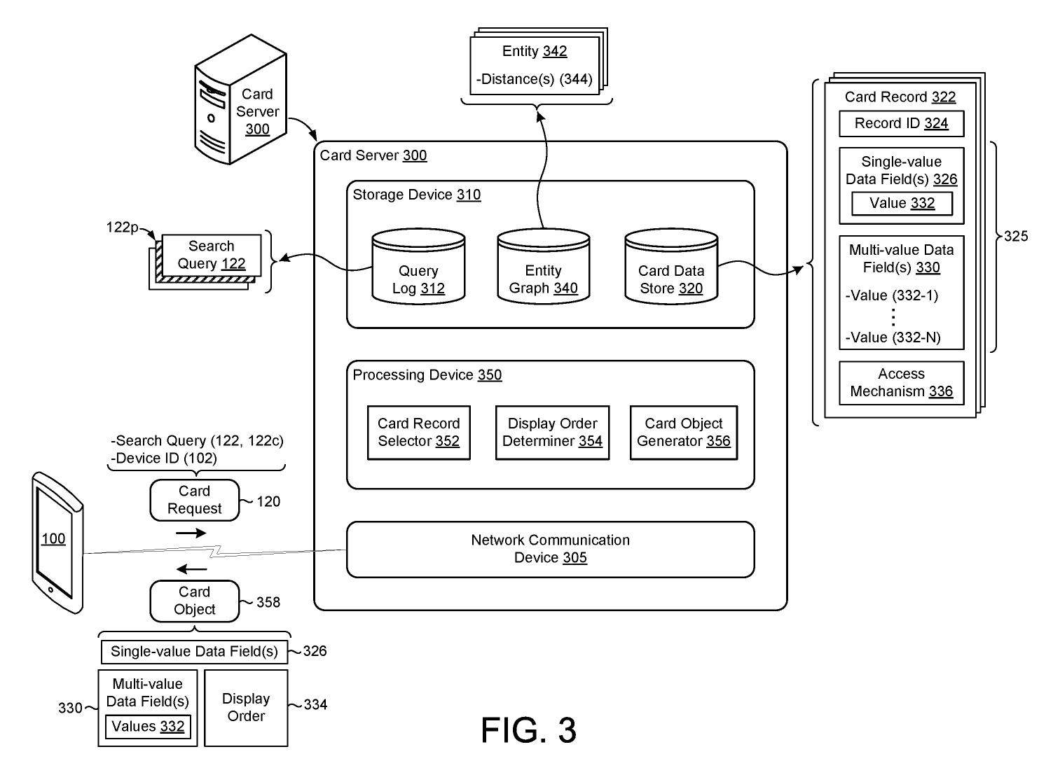

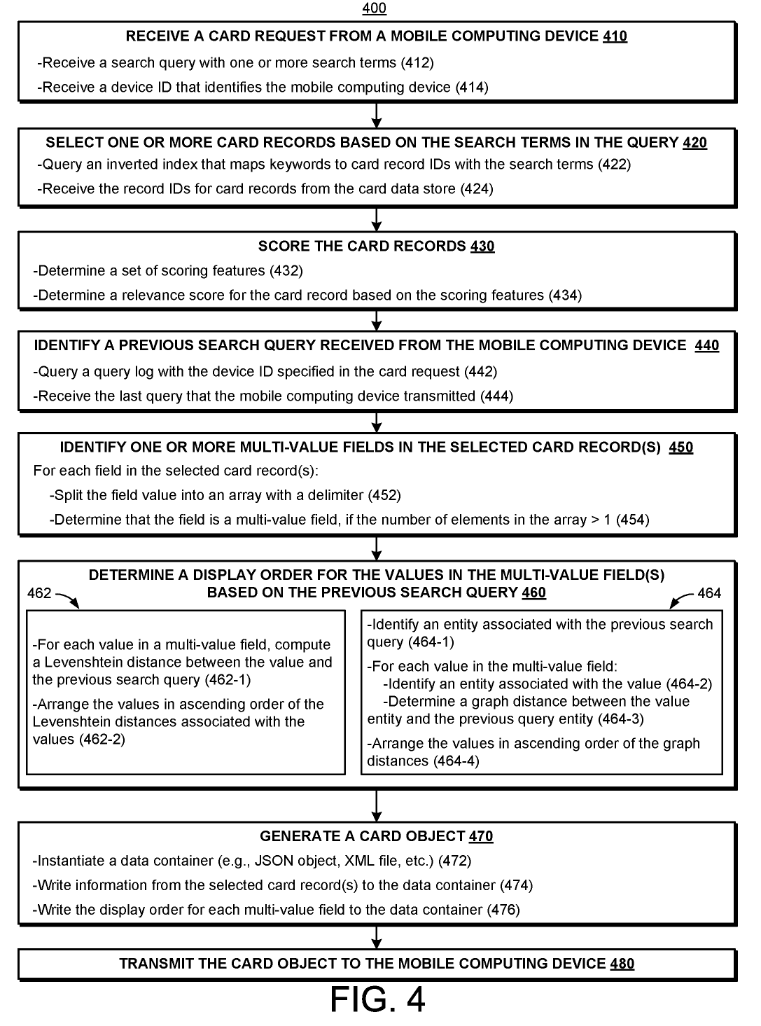

In the example of FIG. 2C, the current search query 122c is “The Dark Knight”, and the previous search query 122p-3 was “Batman”. In this example, the previous search query 122p-3 affects the display order 334 for the actor values 332-7, 332-8, 332-9 in the actor field 330-3, and the display order 334 for the reviews 332-10, 332-11, 332-12 in the reviews field 330-4. Since Christian Bale 332-8 played the role of “Batman” in The Dark Knight, Christian Bale 332-8 is displayed before Heath Ledger 332-7, and Michael Caine 332-9. As described in related to FIGS. 3 and 4, the card server 300 may boost the rank of a value 332 within the display order 334, if the value 332 and the previous search query 122p correspond with similar (e.g., same) entities. Also, the second review 332-11 is displayed before the first review 332-10 because the second review 332-11 includes the search terms of the previous search query 122p-3.

Referring to the example of FIG. 2D, in addition to, or as an alternative to determining a display order 334, the card server 300 can also determine a formatting style for the values 332 in the multi-value data field 330 based on the previous search query 122p. For example, the card server 300 can highlight values 332 that are more relevant to the previous search query 122p. Specifically, the card server 300 can render the text of the value 332 in bold, increase the size of the text, highlight the text, and/or place a geometric shape around the text (e.g., a box, as exemplified in FIG. 2D).

FIG. 3 illustrates an example block diagram for the card server 300. The card server 300 may include a network communication device 305, a storage device 310, and a processing device 350. The card server 300 may be implemented by a cloud computing platform. The cloud computing platform may include a collection of remote computing services. The cloud computing platform may include computing resources (e.g., the processing device 350). The computing resources may include physical servers that have physical central processing units (pCPUs). The cloud computing resources may include storage resources (e.g., the storage device 310). The storage resources may include database servers that support NoSQL, MySQL, Oracle, SQL Server, or the like. The cloud computing platform may include networking resources (e.g., the network communication device 305). Example cloud computing platforms include Amazon Web Services®, Google Cloud Platform®, Microsoft AZURE™ and Alibaba Aliyun™.

The network communication device 305 communicates with a network (e.g., the network 30 shown in FIG. 1). The network communication device 305 may include a communication interface that performs wired communication (e.g., via Ethernet, Universal Serial Bus (USB) or fiber-optic cables). The network communication device 305 may perform wireless communication (e.g., via Wi-Fi, Bluetooth, Bluetooth Low Energy (BLE), Near Field Communications (NFC), ZigBee, a cellular network, or satellites). The network communication device 305 may include a transceiver. The transceiver may operate in accordance with an Institute of Electrical and Electronics Engineers (IEEE) specification (e.g., IEEE 802.3 or IEEE 802.11). The transceiver may operate in accordance with a 3rd Generation Partnership Project (3GPP) specification (e.g., Code Division Multiple Access (CDMA), Long Term Evolution (LTE), or LTE-Advanced). The transceiver may operate in accordance with a Universal Serial Bus (USB) specification (e.g., via a USB port).

The storage device 310 stores data. The storage device 310 may include one or more computer readable storage mediums. For example, the storage device 310 may include solid state memory devices, hard disk memory devices, optical disk drives, read-only memory, and/or nanotube-based storage devices. The storage device 310 may be connected to the processing device 350 via a bus, and/or a network. Different storage mediums within the storage device 310 may be located at the same physical location (e.g., in the same data center, same rack, or same housing). Different storage mediums of the storage device 310 may be distributed (e.g., in different data centers, different racks, or different housings). The storage device 310 may store a query log 312, a card data store 320, and an entity graph 340.

The query log 312 stores search queries 122 that the card server 300 receives from various mobile computing devices 100. The query log 312 can store the search queries 122 in association with device IDs 102 that identify the mobile computing device 100 that sent the search query 122. In addition, each search query 122 in the query log 312 may be associated with a timestamp that indicates a time at which the card server 300 received the search query 122. Alternatively, the timestamp may indicate a time at which the mobile computing device 100 transmitted the search query 122 to the card server 300. Each search query 122 may also be associated with a device location that indicates a location of the mobile computing device 100 when the mobile computing device 100 sent the search query 122 to the card server 300.

The card data store 320 stores card records 322. The card records 322 store information that can be utilized to display the application cards 130 at the mobile computing device 100. Each card record 322 may include a record ID 324. The record ID 324 may include a string that identifies the card record 322. The card record 322 may include one or more data fields 325. A data field 325 can store one or more values 332. A data field 325 that stores a single value 332 may be referred to as a single-value data field 326. A data field 325 that stores more than one value 332 may be referred to as multi-value data field 330. Each multi-value data field 330 stores multiple values 332 (e.g., value 332-1, . . . value 332-N). A value 332 may include a text string, an image, a video, and/or an audio.

The card records 322 may correspond with application states of various applications. For example, the card records 322 may correspond with application states of native applications that can be installed at mobile computing devices 100. The card records 322 may correspond with application states of web applications (e.g., with webpages of a website). The data fields 325 of a card record 322 may store information that the corresponding application state displays. For example, if a card record 322 corresponds with an application state that displays information about The Dark Knight movie, then the card record 322 may include single-value data fields 326 for the movie title, the release year, etc. In this example, the card record 322 may include multi-value data fields 330 for the actors in the movie, the ratings for the movie, the reviews for the movie, etc.

A card record 322 may also store an access mechanism 336. The access mechanism 336 may be used to access an application. The access mechanism 336 can provide access to a native application that may be installed at the mobile computing device 100. Alternatively or additionally, the access mechanism 336 may provide access to a web application. The access mechanism 336 may include a uniform resource identifier (URI) that identifies a resource, and provides access to the resource. The access mechanism 336 may include an application resource identifier (ARI) that identifies a resource (e.g., a state) with an application, and provides access to the resource. The access mechanism 336 may include a link. For example, the access mechanism 336 may include a web uniform resource locator (URL) that links to a webpage, or an application URL that links to an application state.

The entity graph 340 stores information regarding various entities 342. An entity 342 may refer to any physical or logical object (e.g., a person, a place, or a thing). The entity 342 may refer to a tangible item (e.g., products sold in brick-and-mortar stores), or an intangible item (e.g., digital goods such as movies, software applications, etc.). The entity graph 340 may include various nodes that are connected with graph edges. Each graph node may store information regarding an entity 342. The entity graph 340 may also store a distance 344 between a first graph node that corresponds with a first entity 342, and a second graph node that corresponds with a second entity 342. The distance 344 may indicate the number of graph edges between the first graph node, and the second graph node. The entity graph 340 may store additional distances 344 that indicate the number of edges between the first graph node, and all other graph nodes in the entity graph 340.

The processing device 350 may include a collection of one or more computing processors that execute computer readable instructions. The computing processors of the processing device 350 may operate independently or in a distributed manner. The computing processors may be connected via a bus and/or a network. The computing processors may be located in the same physical device (e.g., same housing). The computing processors may be located in different physical devices (e.g., different housings, for example, in a distributed computing system). A computing processor may include physical central processing units (pCPUs). A pCPU may execute computer-readable instructions to implement virtual central processing units (vCPUs). The processing device 350 may execute computer-readable instructions that correspond with a card record selector 352, a display order determiner 354, and/or a card object generator 356.

The card record selector 352 selects one or more card records 322 from the card data store 320 based on the search query 122. The card record selector 352 can select the card records 322 by comparing the search terms of the search query 122 with the data fields 325 stored in the card records 322. The card record selector 352 can select a card record 322 based on a comparison between search terms in the search query 122, and values 332 of the data fields 325. Specifically, the card record selector 322 can select a card record 322, if the card record 322 includes all the search terms in the search query 122. In some implementations, the card data store 220 may include a data structure (e.g., an inverted index) that maps keywords to the record IDs 324. In such implementations, the card record selector 352 can query the data structure with the search terms of the search query 122. In return, the card record selector 352 can receive the record ID(s) 324 for the card record(s) 322 that correspond with the search query 122.

In some implementations, the card record selector 352 may tokenize the search query 122 prior to selecting the card records 322 from the card data store 320. Tokenizing the search query 122 may refer to generating parsed tokens from the search terms of the search query 122. The card record selector 352 can use a tokenizer to tokenize the search query 122. The tokenizer can use various techniques to generate the tokens. In some examples, the tokenizer generates the tokens by splitting the characters of the search query 122 with a given delimiter (e.g., “ ”). The card server 300 can perform various other operations to the search query 122 prior to selecting the card records 322. For example, the card server 300 may perform stemming by reducing the words in the search query 122 to their stem word, or root word. The card server 300 can perform synonymization by identifying synonyms of search terms in the search query 122. The card server 300 can also perform stop word removal by removing commonly occurring words from the search query 122 (e.g., by removing “a”, “and”, etc.). The card server 300 may also identify misspelled words, and replace the misspelled words with the correct spelling. Some of the operations described herein may be referred to as ‘cleaning’ the search query 122.

In some implementations, the card record selector 352 can score the selected card records 322. Scoring the selected card record 322 may refer to generating a relevance score for the selected card record 322. The relevance score for the selected card record 322 may indicate how relevant the selected card record 322 is to the search query 122. The card record selector 352 can compute a set of scoring features for the selected card record 322, and determine a relevance score for the selected card record 322 based on the scoring features. The scoring features may include record scoring features, query scoring features, and/or record-query scoring features.

A record scoring feature may be associated with a card record 322. A record scoring feature may include data associated with an application state that corresponds with the card record 322. For example, a record scoring feature may include values from the one or more single-value data fields 326. A record scoring feature may include parameters related to the application state that corresponds with the card record 322. A record scoring feature may include data that indicates a popularity of the corresponding application state. For example, a record scoring feature may indicate a number of times that the card record 322 has been utilized to generate an application card 130 at a mobile computing device 100. A record scoring feature may indicate a rating of the corresponding application state (e.g., a number of stars associated with the application state). A record scoring feature may include a Boolean value that indicates whether the card record 322 includes a multi-value data field 330. A record scoring feature may include the number of multi-value data fields 330 in the card record 322.

A query scoring feature may be associated with the search query 122. A query scoring feature may include data associated with the search query 122. Example query scoring features may include a number of words in the search query 122, a popularity of the search query 122, and/or an expected frequency of the words in the search query 122. A record-query scoring feature may include data that may be generated based on data associated with the selected card record 322, and the search query 122. A record-query scoring feature may include parameters that indicate a number of matches between the terms of the search query 122, and the selected card record 322.

A record-query scoring feature may include data that may be generated based on data associated with the selected card record 322, and a previous search query 122p received from the mobile computing device 100. For example, the record-query scoring feature may include a Boolean value that indicates whether the previous search query 122p matches any of the values 332 in a multi-value data field 330. A record-query scoring feature may indicate the number of multi-value data fields 330 that include values 332 that match the search terms of the previous search query 122p. Other scoring features are also contemplated.

The display order determiner 354 determines a display order 334 for the values 332 in a multi-value data field 330. The display order determiner 354 may determine the display order 334 for the values 332 based on a previous search query 122p that the card server 300 received from the mobile computing device 100. The display order determiner 354 may identify the previous search query 122p based on the search queries 122 stored in the query log 312. For example, the display order determiner 354 can query the query log 312 with the device ID 102 specified in the card request 120. Upon querying the query log 312 with the device ID 102 in the card request 120, the display order determiner 354 can receive the previous search query 122p that the card server 300 received from the mobile computing device 100.

The display order determiner 354 identifies one or more multi-valued fields 330 in the selected card record 332. The display order determiner 354 can identify a multi-valued field 330 by determining whether a data field 325 has more than one value 332. In some implementations, the display order determiner 354 may parse a data field 325 to determine whether the data field 325 has multiple values 332. For example, the display order determiner 354 can split the data field 325 into an array with a given delimiter (e.g., “ ”, “;”, “,”, etc.). Upon splitting the data field 325 into an array, the display order determiner 354 can count the number of elements in the array. If number of elements in the array is greater than one, then the display order determiner 354 can determine that the data field 325 is a multi-value data field 330. Hence, the display order determiner 354 can determine the display order 334 for the values 332 in this multi-value data field 330.

The display order determiner 354 determines the display order 334 for the values 332 in the multi-value data field 330 based on the previous search query 122p. In some implementations, the display order determiner 354 can compare the previous search query 122p with each of the values 332 in the multi-value data field 330. Values 332 that match the previous search query 122p can be ranked higher in the display order 334, while values 332 that do not match the previous search query 122p may be ranked lower in the display order 334. Values 332 that are ranked higher can be displayed towards the top in the application card 130, while values 332 that are ranked lower can be displayed towards the bottom in the application card 130.

The display order determiner 354 may determine the display order 334 for the values 332 by computing a dissimilarity score for each value 332. The dissimilarity score for a particular value 332 may indicate a level of dissimilarity between the value 332, and the previous search query 122p. If the value 332, and the previous search query 122p are the same, then the dissimilarity score may be zero. Upon computing the dissimilarity scores for all the values 332 of the multi-value data field 330, the display order determiner 354 can arrange the values 332 in ascending order of the dissimilarity scores.

In some examples, computing the dissimilarity score may include computing a Levenshtein distance. The Levenshtein distance may refer to a string metric that measures a difference between two strings. For example, the Levenshtein distance between two strings may refer to the minimum number of single-character modifications (e.g., insertions, deletions, or substitutions) that may be required to change one string into another. In such examples, the display order determiner 354 can compute a Levenshtein distance between a value 332, and the previous search query 122p. Upon computing the Levenshtein distances for all values 332 in the multi-value display field 330, the display order determiner 354 can arrange the values 332 in ascending order of the Levenshtein distances. Lower values of the Levenshtein distances indicate a higher degree of similarity, whereas higher values of the Levenshtein distances indicate a lower degree of similarity. For example, if the Levenshtein distance between a particular value 332 and the previous search query 122p is zero, then the display order determiner 354 can determine that the value 332 matches the previous search query 122p. In this example, the value 332 that matches the previous search query 122p may be assigned a rank of one in the display order 334, so that the value 332 appears above other values 332 within the multi-value data field 330.

In some implementations, the display order determiner 354 can determine the display order 334 for the values 332 in the multi-value data field 330 based on the entities 342 that are associated with the values 332. For example, if a particular value 332 is associated with the same entity 342 as the previous search query 122p, then that particular value 332 may be assigned a higher rank in the display order 334. The display order determiner 354 can determine the entity 342 associated with the previous search query 122p based on the entities 342 stored in the entity graph 340. For example, the display order determiner 354 can query the entity graph 340 with the search terms of the previous search query 122p. In response to querying the entity graph 340 with the previous search query 122p, the display order determiner 354 can receive the entity 342 associated with the previous search query 122p. Similarly, the display order determiner 354 can determine the entities 342 associated with all the values 332. Values 332 that are associated with the same entity 342 as the previous search query 122p can be ranked higher in the display order 334.

Each entity 342 may be represented by a node in the entity graph 340. In some implementations, the display order determiner 354 may determine the display order 334 based on distances 344 between representative nodes. For each value 332, the display order determiner 354 can determine a distance 344 between a first entity 342 that corresponds with the previous search query 122p, and a second entity 342 that corresponds with the value 332. Upon determining the distances 344 for all the values 332 in a multi-value data field 330, the display order determiner 354 can arrange the values 332 based on the distances 344. For example, the display order determiner 354 can arrange the values 332 in ascending order of the distances 344. The display order determiner 354 can determine a distance 344 between a first node and a second node by counting a number of edges between the first node and the second node. Alternatively, the display order determiner 344 can determine the distance 344 between a first node and a second node by querying the entity graph 340 (e.g., if the entity graph 340 stores the distances 344 between different nodes).

The card object generator 356 generates the card object 358. The card object 358 includes the values 332 from the selected card record(s) 332. For example, the card object 358 may include the values 332 from the single-value data field(s) 326, and the multi-value data field(s) 330 of the selected card record(s) 322. For each multi-value data field 330 included in the card object 358, the card object generator 356 may include the display order 334 in which the values 332 can be displayed at the mobile computing device 100. The card object generator 356 can instantiate a data container that represents the card object 358. The data container may include a JSON (JavaScript Object Notation) object, an XML (Extensible Markup Language) file, etc. Upon instantiating the data container, the card object generator 356 can write the values 332 of a multi-value data field 330, and the display order 334 for the values 332 to the data container. Upon generating the card object 358, the card object generator 356 can transmit the card object 358 to the mobile computing device 100 via the network communication device 305.

FIG. 4 illustrates a method 400 for determining a display order for values in a multi-value data field of an application card. The method 400 can be implemented as a set of computer readable instructions that may be executed by a computing processor of a card server (e.g., the processing device 350 of the card server 300 shown in FIG. 3). Generally, the card server receives a card request from a mobile computing device (at 410). The card request includes a search query. At 420, the card server selects one or more card records from a card data store based on the search terms in the search query. The card server can score the selected card records (at 430). At 440, the card server identifies a previous search query that the card server received from the mobile computing device. At 450, the card server identifies one or more multi-value data fields in the selected card record. The card server determines a display order for the values within the multi-value data field based on the previous search query (at 460). At 470, the card server generates a card object that includes the values from the multi-value data field, and indicates the display order for the values. At 480, the card server transmits the card object to the mobile computing device.

At 410, the card server receives a card request from a mobile computing device. Receiving the card request may include receiving a search query with one or more search terms (at 412). The search query in the card request may be referred to as a current search query. Receiving the card request may also include receiving a device ID that identifies the mobile computing device that initiated the card request (at 414). The card request may include other information. For example, the card request may include contextual data such as sensor values (e.g., a location of the mobile computing device), application IDs that identify the applications that are installed at the mobile computing device, etc.

At 420, the card server selects one or more card records based on the search terms in the search query. The card server can select the card records by comparing the search terms with the information that is stored in the card records. For example, the card server can compare the search terms with the values of the data fields that are stored in the card record. If the search terms match the values of the data fields of a card record, then the card server can select the card record. Similarly, if a card record includes all of the search terms, or a majority of search terms (e.g., more than a threshold percentage) then the card server can select that particular card record. In some implementations, the card data store may include a data structure that maps keywords to card record IDs that identify the card records. The data structure may include an index (e.g., an inverted index), a lookup table, etc. The card server can query the data structure with the search terms of the current search query (at 422). Upon querying the data structure with the current search query, the card server can receive the record IDs for card records from the card data store (at 424). The record IDs that the card server receives identify card records that may be relevant to the current search query. In some implementations, the card server may tokenize the current search query, and/or clean the search query (as described in relation to FIG. 3).

At 430, the card server scores the selected card records. Scoring the selected card records may include determining a set of scoring features (at 432). Upon determining the scoring features, the card server can determine a relevance score for the card record based on the scoring features (at 434). As described herein, determining the scoring features may include computing a query scoring feature, a record scoring feature, and/or a record-query scoring feature. Determining the relevance score may include utilizing a machine learned model that receives the scoring features for a card record as an input, and outputs the relevance score for the card record.

At 440, the card server identifies a previous search query that the card server received from the mobile computing device. The card server may store a query log that stores all the search queries that the card server receives. Each search query in the query log may be stored in association with a device ID that identifies the mobile computing device that sent the search query. The card server can retrieve a device ID from the card request, and query the query log with the device ID specified in the card request (at 442). At 444, the card server can receive a previous search query that the card server received from the mobile computing device. The previous search query may be the last search query that the card server received from the mobile computing device.

In some implementations, each search query in the query log may also be associated with a device location. The device location associated with a search query may refer to a location of the mobile computing device at a time when the mobile computing device sent the search query to the card server. The card request may include a current device location that indicates a current location of the mobile computing device. In such implementations, the card server can identify the last search query that the card server received from the mobile computing device when the mobile computing device was at the current location. The card server may identify such a search query by querying the query log with the device ID, and the current device location of the mobile computing device indicated in the card request.

At 450, the card server identifies one or more multi-value data fields in the selected card record. Identifying the multi-value data field may include identifying a field that includes multiple values. In other words, identifying the multi-value data field may include identifying a data field that includes more than one value. In some implementations, the card record may split the field values into an array using a delimiter (at 452). The card server can determine a number of elements in the resulting array. If the number of elements in the resulting array is greater than one, then the card server can determine that the data field is a multi-value data field (at 454).

At 460, the card server determines a display order for values in the multi-value data field based on the previous search query. The card server can determine the display order based on the similarity between the values, and the previous search query (at 462). Alternatively or additionally, the card server can determine the display order for the values based on the degree of proximity between graph nodes that represent entities that are associated with the values, and the previous search query (at 464).

Referring to 462, for each value, the card server can compute a dissimilarity score between the value, and the previous search query (at 462-1). The dissimilarity score can indicate the degree of dissimilarity between the value, and the previous search query. A dissimilarity score of zero may indicate that there is no dissimilarity, and that the value and the previous search query are the same. A higher dissimilarity score may indicate that the value and the previous search query are not the same. In some examples, the dissimilarity score may be a Levenshtein distance that indicates the number of modifications it takes to turn one string into another. In such examples, for each value, the card server can compute a Levenshtein distance between the value, and the previous search query. If the value is equal to the previous search query, then the Levenshtein distance is zero, otherwise the Levenshtein distance is a non-zero number.

At 462-2, the card server can arrange the values based on the dissimilarity scores associated with the values. Specifically, the card server can arrange the values in ascending order of the dissimilarity scores that are associated with the values. In other words, values with lower dissimilarity scores are assigned higher ranks in the display order, whereas values with higher dissimilarity scores are assigned lower ranks in the display order. In other words, a first value is displayed above a second value, if a first dissimilarity score associated with the first value is lower than a second dissimilarity score associated with the second value.

Referring to 464, the card server can identify an entity associated with the previous search query (at 464-1). For example, the card server can query the entity graph with the previous search query, and receive the entity that is associated with the previous search query. For each value in the multi-value data field, the card server can identify an entity that is associated with the value (at 464-2). The card server can identify the entity associated with the value by querying the entity graph with the value, and receiving the entity in return. Upon identifying the entity that is associated with a value, the card server can determine a distance between a first node that represents the entity associated with the previous search query, and a second node that represents the entity associated with the value. The card server may utilize Dijkstra's algorithm to determine the shortest path between the nodes, and then count the number of edges on the shortest path to determine the distance. Other techniques are also contemplated. At 464-4, the card server can arrange the values in ascending order of the distances.

At 470, the card server generates a card object. Generating the card object may include instantiating a data container (at 472). The data container may include a JSON object, an XML file, etc. The card server can write information from the selected card record into the data container (at 474). The information may include a value from a single-value data field, and values from a multi-value data field. At 476, the card server writes the display order for the values in the multi-value data field into the data container. At 480, the card server transmits the card object to the mobile computing device.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., LCD (liquid crystal display) monitor, or touch screen for displaying information to the user and optionally a keyboard and a pointing device, e.g., a mouse, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A card server comprising:
a network communication device;
a storage device that stores:
a query log that stores search queries that the card server receives from mobile computing devices;
a card data store that stores card records, each card record comprises one or more multi-value data fields, each multi-value data field comprises a plurality of values; and
a processing device that executes computer-readable instructions that, when executed by the processing device, cause the processing device to:
receive a card request from a mobile computing device, the card request comprises a search query with one or more search terms, and a device ID that identifies the mobile computing device;
select one or more card records from the card data store based on the search terms in the search query;
identify a previous search query that the card server received from the mobile computing device based on the search queries stored in the query log;
identify one or more multi-value fields in the selected card record;
for each multi-value field, determine a display order for the plurality of values in the multi-value field based on the previous search query;
generate a card object that comprises the one or more multi-value data fields from the selected card record, and the display order for each multi-value data field; and
transmit the card object to the mobile computing device.

2. The card server of claim 1, wherein each card record is associated with a record ID that identifies the card record, and wherein selecting the one or more card records comprises:
querying a data structure, which maps keywords to the record IDs, with the search terms of the search query; and
receiving the record IDs for the card records that correspond with the search terms.

3. The card server of claim 1, wherein identifying the previous search query comprises:
querying the query log with the device ID specified in the card request; and
receiving the last search query that the card server received from the mobile computing device.

4. The card server of claim 1, wherein identifying the multi-value field in the card record comprises identifying a field that includes more than one value.

5. The card server of claim 1, wherein identifying the multi-value field in the card record comprises:
splitting a value of a field into an array with a delimiter;
determining a number of elements in the array; and
determining that the field is a multi-value field, if the number of elements in the array is greater than one.

6. The card server of claim 1, wherein determining the display order for the values in the multi-value field comprises:
for each value, determining a dissimilarity score that indicates an amount of dissimilarity between the value and the previous search query; and
arranging the values in ascending order of the dissimilarity scores associated with the values.

7. The card server of claim 6, wherein determining the dissimilarity score comprises computing a Levenshtein distance between the value and the previous search query.

8. The card server of claim 1, wherein the storage device stores an entity graph that stores information regarding entities; and wherein determining the display order for the values in the multi-value field comprises:
identifying an entity associated with the previous search query based on the entity graph;
for each value in the multi-value field:
identifying an entity associated with the value; and
determining a graph distance between a graph node that corresponds with the entity associated with the previous search query, and another graph node that corresponds with the entity associated with the value; and
arranging the values in ascending order of the graph distances associated with the values.

9. The card server of claim 1, wherein generating the card object comprises:
instantiating a data container;
writing the multi-value fields from the selected card record into the data container; and
for each multi-value field, writing the display order for the values in the multi-value field into the data container.

10. The card server of claim 1, wherein the processing device further executes computer-readable instructions that, when executed by the processing device, cause the processing device to:
compute a set of scoring features; and
determine a relevance score for each of the selected card records based on the scoring features.

11. A computer-implemented method for providing a card object that can be utilized to render an application card, the computer-implemented method comprising:
storing, at a storage device of a card server, a query log that stores search queries that the card server receives from mobile computing devices;
storing, at the storage device, a card data store that stores card records, each card record comprises one or more multi-value data fields, each multi-value data field comprises a plurality of values;
receiving, via a network communication device of the card server, a card request from a mobile computing device, the card request comprises a search query with one or more search terms, and a device ID that identifies the mobile computing device;
selecting, by a processing device of the card server, one or more card records from the card data store based on the search terms in the search query;
computing, at the processing device, a set of scoring features for the one or more selected card records;
determining, by the processing device, a relevance score for each of the one or more selected card records based on the scoring features;
identifying, by the processing device, a previous search query that the card server received from the mobile computing device based on the search queries stored in the query log;
identifying, by the processing device, one or more multi-value fields in the selected card record;
for each multi-value field, determining, at the processing device, a display order for the plurality of values in the multi-value field based on the previous search query;
generating, at the processing device, a card object that comprises the one or more multi-value data fields from the selected card record, and the display order for each multi-value data field; and
transmitting, via the network communication device, the card object to the mobile computing device.

12. The computer-implemented method of claim 11, wherein identifying the previous search query comprises:
querying the query log with the device ID specified in the card request; and
receiving the last search query that the card server received from the mobile computing device.

13. The computer-implemented method of claim 11, wherein determining the display order for the values in the multi-value field comprises:
for each value, determining a dissimilarity score that indicates an amount of dissimilarity between the value and the previous search query; and
arranging the values in ascending order of the dissimilarity scores associated with the values.

14. The computer-implemented method of claim 13, wherein determining the dissimilarity score comprises computing a Levenshtein distance between the value and the previous search query.

15. The computer-implemented method of claim 11, wherein the computer-implemented method further comprises storing, at the storage device, an entity graph that stores information regarding entities; and wherein determining the display order for the values in the multi-value field comprises:
identifying an entity associated with the previous search query based on the entity graph;
for each value in the multi-value field:
identifying an entity associated with the value; and
determining a graph distance between a graph node that corresponds with the entity associated with the previous search query, and another graph node that corresponds with the entity associated with the value; and
arranging the values in ascending order of the graph distances associated with the values.

16. A computer program product encoded on a non-transitory computer readable storage medium comprising instructions that when executed by a processing device, of a card server, cause the processing device to perform operations comprising:
storing, at a storage device of the card server, a query log that stores search queries that the card server receives from mobile computing devices;
storing, at the storage device, a card data store that stores card records, each card record comprises one or more multi-value data fields, each multi-value data field comprises a plurality of values;
receiving, via a network communication device of the card server, a card request from a mobile computing device, the card request comprises a search query with one or more search terms, and a device ID that identifies the mobile computing device;
selecting, by the processing device, one or more card records from the card data store based on the search terms in the search query;
computing, at the processing device, a set of scoring features for the one or more selected card records;
determining, by the processing device, a relevance score for each of the one or more selected card records based on the scoring features;
identifying, by the processing device, a previous search query that the card server received from the mobile computing device based on the search queries stored in the query log;
identifying, by the processing device, one or more multi-value fields in the selected card record;
for each multi-value field, determining, at the processing device, a display order for the plurality of values in the multi-value field based on the previous search query;
generating, at the processing device, a card object that comprises the one or more multi-value data fields from the selected card record, and the display order for each multi-value data field; and
transmitting, via the network communication device, the card object to the mobile computing device.

17. The computer program product of claim 16, wherein identifying the previous search query comprises:
querying the query log with the device ID specified in the card request; and
receiving the last search query that the card server received from the mobile computing device.

18. The computer program product of claim 16, wherein determining the display order for the values in the multi-value field comprises:
for each value, determining a dissimilarity score that indicates an amount of dissimilarity between the value and the previous search query; and
arranging the values in ascending order of the dissimilarity scores associated with the values.

19. The computer program product of claim 18, wherein determining the dissimilarity score comprises computing a Levenshtein distance between the value and the previous search query.

20. The computer program product of claim 16, wherein the operations further comprise storing, at the storage device, an entity graph that stores information regarding entities; and wherein determining the display order for the values in the multi-value field comprises:
identifying an entity associated with the previous search query based on the entity graph;
for each value in the multi-value field:
identifying an entity associated with the value; and
determining a graph distance between a graph node that corresponds with the entity associated with the previous search query, and another graph node that corresponds with the entity associated with the value; and
arranging the values in ascending order of the graph distances associated with the values.
